(19) United States
(12) Patent Application Publication
(10) Pub. No.: US 2004/0053192 A1
(43) Pub. Date: Mar. 18, 2004

(54) Handle or angled member for dental tool

(76) Inventors: Rainer Schneider, St. Pantaleon (AT); Michael Mangelberger, St. Georgen bei Salzburg (AT)

Correspondence Address: Friedrich Kueffner, Suite 910, 317 Madison Avenue, New York, NY, 10017, US

(21) Appl. No.: 10/622,074

(22) Filed: Jul. 16, 2003

(30) Foreign Application Priority Data
Jul. 16, 2002 (AT) A 1069/2002

(51) Int. Cl. A61C 3/00

(52) U.S. Cl. 433/114; 433/82

(57) ABSTRACT

A handle for a dental tool has a sleeve having a first end provided with a head and having a second end. An air turbine, for driving a tool, is arranged in the head of the sleeve. A connector is connected to the second end of the sleeve and is to be attach to a supply hose or an intermediate member. At least one driving air conduit for supplying driving air to the air turbine is provided. The at least one driving air conduit has a conduit end. An insert member is inserted into the sleeve and positioned proximal to the head of the sleeve. The conduit end of the at least one driving air conduit is arranged in the insert member.

### BACKGROUND OF THE INVENTION

1. Field of the Invention

The invention relates to a handle or angled member for a dental tool, comprising a turbine operated by compressed air for driving a tool, further comprising a sleeve and a connector part for connecting the handle to a supply line or to an intermediate member, and comprising at least one driving air conduit, wherein optionally a return air conduit and/or at least one light guide and/or at least one medium conduit is provided also. The invention also relates to a method for manufacturing such a handle or angled member.

2. Description of the Related Art

Such handles are known in different configurations.

U.S. Pat. No. 3,061,390 discloses a dental tool handle with a component in which the spray water conduit is enclosed. The component is part of the outer sleeve and must therefore be connected to the other parts of the outer sleeve (illustrated in FIG. 1 in the form of a screw connection). Since the end of the part facing the turbine directly forms a part of the turbine chamber, this end is of a very complex configuration.

U.S. Pat. No. 3,255,527 discloses a handle in which, according to col. 8, lines 69ff, the conduits for the compressed air and the return air as well as the small pipes for the spray liquid and the spray air are soldered together and form the front part of the handle (neck tube) which, in turn, is connected by soldering to the head part. The lines which are soldered together form a section of the housing itself.

The configuration of U.S. Pat. No. 4,318,695 corresponds to the above described structure of the prior art patent but the handle sleeve is not of a unitary configuration but is comprised of two parts, as illustrated in FIG. 2.

U.S. Pat. No. 4,117,597 discloses a similar handle but its head part is comprised of three outer parts: a top part, a bottom part, and a separating plate.

Such handles and angled members, referred to in the following as turbines, serve for removal of caries-infected tooth material and for producing cavities in preparation for filling a tooth. Turbines have been widely used for this task for some time and are used worldwide today. Based on the experiences and requirements presented by the user, as well as the related developmental work of the manufacturer, the configuration of turbines has become more and more complex over the years. In addition to lines or conduits for supplying the driving air as well as for removing the return air, turbines can also comprise auxiliary devices such as light guides for illuminating the working area and/or medium conduits for a spray to be targeted during treatment onto and around the tip of the tool.

The light guide can be, for example, a glass rod or a fiberglass rod wherein, as a function of the number of exit openings for the light on the turbine head, it is also possible that several light guides are guided through the handle of the turbine or that a light guide may be divided into several strands.

The media conduits for the spray can have separate lines for spray water and chip air; when the two media are then mixed in a mixing chamber within the handle, a common spray conduit extends to one or several exit openings for the spray.

Turbines are high-speed instruments, and it is required that they perform up to 400,000 rpm as well as provide a corresponding torque. In order to fulfill these requirements and to ensure at the same time smooth running as much as possible while having only a minimal noise emission, the geometry and the configurations of the components in the area of the turbine head are primarily of great importance. Accordingly, the shape and the diameter of the driving air conduit and of the return air conduit, the location where they pass through the wall of the housing of the head, the shape of the wall of the head housing, possibly present recesses or projections for directing the airflow, for example, in the form of deflector plates, affect significantly the technical properties of turbines.

Assembly of the turbines according to the prior art is carried out in several steps, as will be described in the following in connection with FIG. 1. Starting with a drop-forged head/neck blank 1 of solid material, three bores 4 are drilled into the cylindrical neck part in accordance with the number of medium conduits and light guides 3. The truncated cone head part is also drilled to provide a bore; into the thus resulting head sleeve of the turbine the projections and recesses for guiding the driving air are machined subsequently. After the subsequent surface treatment of this head/neck component 1 the medium and light guide conduits 3 are inserted into the bores 4 of the head/neck component 1 and fastened by gluing. The rotor 5 with the clamping system and the pushbutton 11 for releasing the tool are mounted in the head, and, subsequently, a grip sleeve 6, produced in a separate working step, is pushed across the medium lines 3 and the neck part of the head-neck component 1 and connected thereto (for example, by gluing). At the end of the grip sleeve 6 (the end facing away from the rotor 5), inserts 7, 8, and 9 and a seal 10 are inserted into the grip sleeve 6 for providing fixation and a standardized connection via the medium lines 3.

A disadvantage of this type of configuration of the turbine and the correlated assembly is that, because of the tight space conditions in the interior of the head part, machining of an optimal geometry for guiding the driving air, primarily in the area of the exit of the driving air from the driving air conduit and in the area of the entry way into the return line, is made rather difficult and the shaping of different geometries as desired for guiding the air is not possible. Since the sleeve of the turbine is manufactured of several parts, the assembly costs, the time required for assembly, and the resulting production costs overall are high.

In a turbine known on the market, the sleeve is comprised of two parts, a head/neck part which is machined out of a blank, as well as a grip sleeve. The two parts are connected to one another by means of a bayonet closure. The media conduits are interrupted and are combined when coupling the two sleeve parts. The chip air and the spray water are guided in the grip sleeve by means of conduits and in the neck/head sleeve via bores in the solid material (without lines). The driving air and return air are transported in the grip part and in the head/neck part in lines wherein in the head/neck part the return air conduit, having a diameter of approximately 5 mm, is guided in a corresponding bore and the driving air line having a significantly reduced diameter is integrated centrally in the return air line.

A disadvantage of this turbine is again the multi-part configuration of the sleeve causing increased manufacturing and mounting expenditures. By separating the lines between grip and head/neck part, additional seals in this area are required. Shaping of different desired geometries in the area of the exit openings of the driving air conduit is also not possible because the driving air line is surrounded by the return air line.

### SUMMARY OF THE INVENTION

It is an object of the present intention to provide an improved turbine with reduced assembly expenditure, in which combining of several sleeve parts is no longer necessary, and with which the possibility is provided of designing the geometry in the area of the openings of the driving air conduit or guide means into the space in which the rotor is supported in any shape.

In accordance with the present invention, this is achieved in that at least one driving air conduit at its end facing the head is surrounded or enclosed in an insert member.

In accordance with the present invention, this is achieved with respect to the method in that the at least one insert member at the end facing the head is machined such that a predetermined geometry for guiding the driving air, in particular, in the area of the exit of the driving air and in the area of the entry of the return air into the return air conduit or into the through opening is provided, in that the conduits to be enclosed according to their task in the insert member are enclosed with their end that is close to the head in the insert member, and in that the insert member, with the attached lines, is inserted via the connector end of the handle of the dental tool through the hollow interior to the head area and is secured thereat.

Since the insert member is a separate component, it can therefore be machined outside of the sleeve in a simple way and with sufficient space being available. Any desired geometry for guiding the driving air, primarily in the area of the exit of the driving air from the driving air conduit and also in the area of the intake or entry way into the return air conduit or guide can thus be produced easily. By enclosing the medium conduits in the insert member, mounting of these components is facilitated. This enables, according to a preferred configuration of the present invention, the manufacture of the outer sleeve of the turbine from a single blank and the insertion of the insert member part with the medium lines into the sleeve to the final position at the head part.

The term “enclosing” the medium conduits is to be understood such that the insert member completely receives and surrounds the medium conduits, for example, by producing a bore in the insert member and inserting a section of the conduit into the insert member; however, the term is meant to include also a situation where a recess is manufactured into the surface of the insert member, for example, by milling, and a conduit is inserted or placed into the recess.

### BRIEF DESCRIPTION OF THE DRAWING

In the drawing:

FIG. 1 shows in an exploded view the configuration of a turbine according to the prior art;

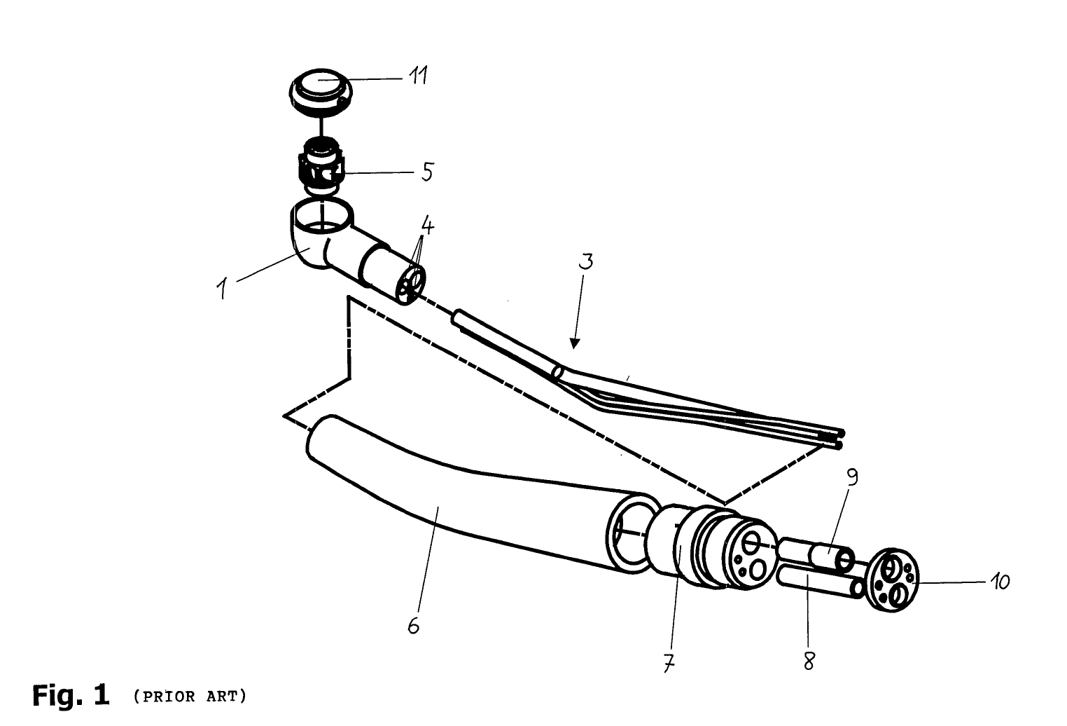

FIG. 2 shows in analogy to FIG. 1 the configuration of a turbine according to the present intention;

FIG. 3 shows an insert member according to the present invention; and

FIG. 4 shows a variant of the insert member.

### DESCRIPTION OF THE PREFERRED EMBODIMENTS

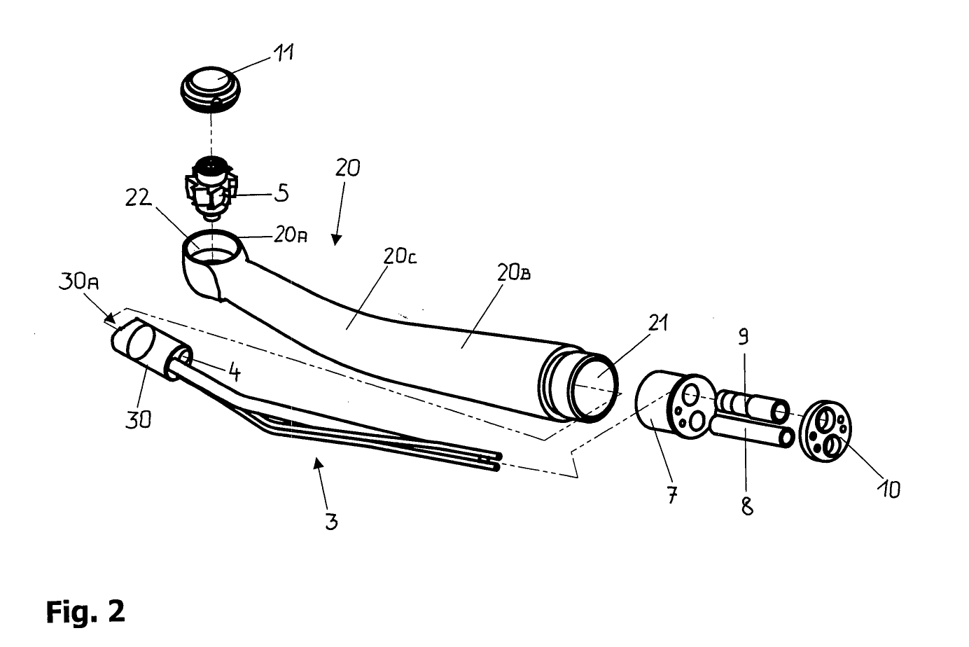

In the handle or angled member of the present invention according to FIG. 2, medium conduits 3 are illustrated which are connected to the insert member 30 by being inserted into the corresponding bores 4. The surface of the end 30A facing the head of the insert member 30 has been machined before insertion of the medium conduits 3 such that any desired geometry for guiding the driving air, primarily in the area of the exit of the driving air from the driving air conduit and in the area of the entry way of the air into the return air conduit, can be manufactured in an uncomplicated way. For example, guiding means can be machined which transmit the driving air flow in an optimal way onto the turbine wheel or into the return air conduit. Also, devices that affect the flow behavior of the driving air can be manufactured, for example, by milling. The shape and size of the openings of the air conduits can also be designed as desired.

The medium conduits 3 are fastened preferably by gluing in the insert member 30 but can also be fixed in position by any other suitable measure. The diameter of the insert member 30 matches the diameter of the inner chamber 21 of the sleeve 20. The component formed of the insert member 30 and the lines or conduits 3 can be inserted into the interior or hollow chamber 21 of the sleeve 20 of the angled member up to the end of head 20A of the angled member and can be positioned so as to be secured against rotation; this can be achieved, for example, by securing the insert member 30 with screws projecting radially through the sleeve 20 or by any other suitable measures. At the end of the sleeve 20 facing the connector, end members 7, 8, and 9 and a seal 10 are inserted into the sleeve 20 for fixation and for a standardized connection via the medium conduits 3.

The entire sleeve 20 of the angled member is preferably produced of a cylindrical blank of solid material. The outer contour is produced by turning, and, subsequently, the interior 21 of the grip area 20B is machined by drilling. In the same way, the hollow chamber 22 of the head area 20A is also machined by drilling. Subsequently, by bending the grip sleeve 20, a bent portion 20C is provided which ensures improved handling and visibility for the user. The medium conduits 3, before they are connected to the insert member 30, are also slightly bent in the same area as the sleeve 20.

The rotor 5 with the clamping system for the tool and the pushbutton 11 for detaching the tool are mounted in the hollow chamber 22 of the head area 20A. Since both components are known in the prior art and a person skilled in the art is familiar with them, these components are not described in any more detail in this connection.

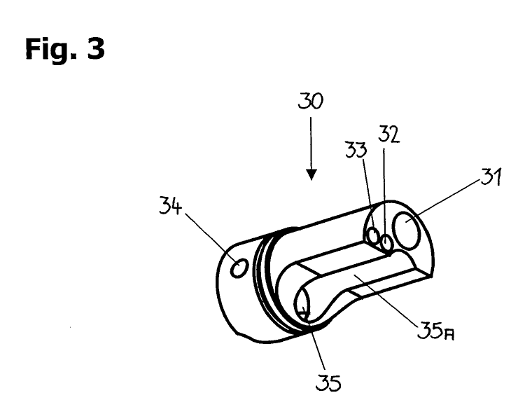

In the particularly preferred embodiment of the insert member 30 illustrated in FIG. 3, the return air is not guided in a conduit but through the interior chamber 21 of the sleeve (FIG. 2). The insert member therefore has only a return air connection for guiding the air in the form of a bore 35 extending from the head area of the sleeve and opening along its further path 35A into the hollow interior 21 of the sleeve. Above the bore 35 for the return air the bore 31 for receiving the driving air conduit is positioned. The two bores 32, 33 serve for enclosing the auxiliary components in the form of the chip air conduit and the water conduit for the spray. Mixing of the two media is realized in a mixing chamber (not illustrated) in the insert member 30 which is positioned upstream of the spray opening 34. In the spray opening 34 a nozzle for atomizing and directing the spray is mounted. The nozzle serves at the same time also for fixation of the insert member 30 in the sleeve of the turbine.

In a variant of this particularly preferred embodiment, it is also possible to guide the return air flow through several bores in the insert member.

The invention is not limited to the illustrated configurations but can also be modified differently, in particular, as a function of the configuration of the turbine. For example, the number of medium conduits and light guides, which are enclosed or guided within the insert member, is variable. It is also not mandatory that all lines or conduits that are present are guided through the insert member.

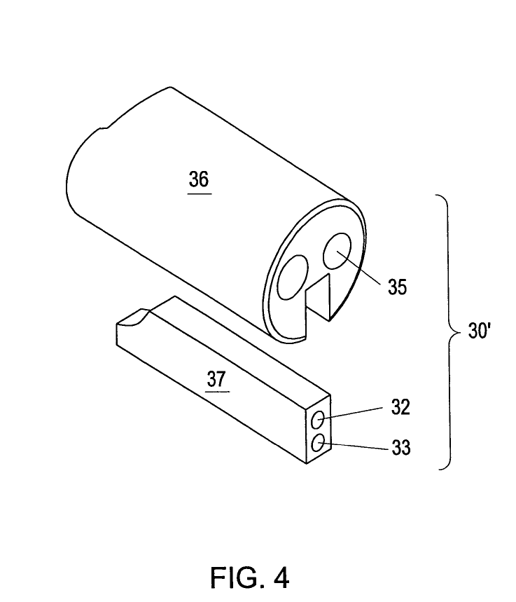

Also, the insert member, as illustrated in FIG. 4, can be of a divided configuration; for example, those lines that “belong” together (for example, the driving air conduit and the return air conduit; the medium conduits for the spray) can be enclosed in separate partial insert member parts. Such a configuration has the advantage that the lines or conduits or channels which, for whatever reasons may be plugged (calcium deposits in the spray water conduits, particles penetrating diverse filters in the compressed air conduit), can be exchanged without continuous conduits having to be exchanged also. The two insert member parts 36, 37 (a division into additional parts is conceivable only in special situation for reasons of proper fit) are preferably matched in regard to their shape to one another such that they can be handled as a complete insert member 30′. In the context of the invention, any type of configuration which prevents disassembly of the insert member parts in a positive-locking or friction-locking way is possible. Of course, a connection by gluing or the like is possible also.

While specific embodiments of the invention have been shown and described in detail to illustrate the inventive principles, it will be understood that the invention may be embodied otherwise without departing from such principles.

What is claimed is:

1. A handle for a dental tool, the handle comprising:
a sleeve having a first end provided with a head and having a second end;
an air turbine, for driving a tool, arranged in the head of the sleeve;
a connector connected to the second end of the sleeve and configured to attach to a supply line or an intermediate member;
at least one driving air conduit for supplying driving air to the air turbine, the at least one driving air conduit having a conduit end;
an insert member inserted into the sleeve and positioned proximal to the head of the sleeve;
wherein the conduit end of the at least one driving air conduit is arranged in the insert member.

2. The handle according to claim 1, further comprising at least one auxiliary component selected from the group consisting of:
at least one light guide; and
at least one medium conduit.

3. The handle according to claim 2, wherein the at least one auxiliary component is arranged in the sleeve and has a forward end enclosed by the insert member.

4. The handle according to claim 3, further comprising a return air conduit formed by an interior of the sleeve not occupied by the at least one auxiliary component, wherein the return air conduit further comprises a fluid connection connecting the head and the interior, wherein the fluid connection is at least one through opening provided in the insert member.

5. The handle according to claim 1, wherein the insert member comprises a mixing chamber for chip air and spray water.

6. The handle according to claim 1, wherein the sleeve is made of a monolithic blank.

7. The handle according to claim 1, wherein the insert member is comprised of several insert member parts.

8. The handle according to claim 7, wherein the insret member parts are connected to form the complete insert member.

9. A method for manufacturing a handle for a dental tool, wherein the handle comprises a sleeve having a first end provided with a head and having a second end; an air turbine for driving a tool arranged in the head of the sleeve; a connector connected to the second end of the sleeve and configured to attach to a supply hose or an intermediate member; at least one driving air conduit for supplying driving air to the air turbine and having a conduit end; at least one auxiliary component selected from the group consisting of at least one light guide and at least one medium conduit; a return air conduit; wherein the at least one auxiliary component is arranged in the sleeve and has a forward end enclosed by the insert member; wherein the method comprises the steps of:
machining the insert member at an end facing the head of the sleeve such that a predetermined geometry for guiding driving air is provided;
arranging and securing a first end of the at least one auxiliary component in the insert member;
inserting the insert member into the sleeve via the second end of the sleeve through an interior of the sleeve to a final position at the head of the sleeve; and
securing the insert member in the final position.

10. The method according to claim 9, wherein in the step of machining an exit area of the driving air conduit and an entry way into the return air conduit are machined.
